(19) United States
(12) Patent Application Publication
(10) Pub. No.: US 2024/0003626 A1
(43) Pub. Date: Jan. 4, 2024

(54) SYSTEMS AND METHODS FOR FIRING GREEN CERAMIC WARE IN A KILN WITH ATMOSPHERIC CONTROL OF OXYGEN

(71) Applicant: CORNING INCORPORATED, CORNING, NY (US)

(72) Inventors: Daniel Burkey, Kaiserslautern (DE); Bernd Geismar, Berlin (DE); Raymar Markus Kreis, Otterberg (DE); Thomas Madison Tebo, III, Horseheads, NY (US)

(21) Appl. No.: 18/251,426

(22) PCT Filed: Nov. 5, 2021
(86) PCT No.: PCT/US2021/058150

§ 371 Date: May 2, 2023

Related U.S. Application Data
(60) Provisional application No. 63/113,564, filed on Nov. 13, 2020.

(51) Int. Cl. F27B 5/18; F27D 7/02; F27D 19/00; B28B 11/24

(52) U.S. Cl. CPC F27B 5/18; F27D 7/02; F27D 19/00; B28B 11/243; F27B 2005/161

(57) ABSTRACT

A method firing green ware. The method for firing includes setting a kiln oxygen concentration set point for an atmosphere of a ware space of a kiln during an oxygen-consuming event in the ware space of the kiln. An oxygen flux control mode is initiated that includes measuring an oxygen concentration of the atmosphere of the ware space in the kiln, comparing the oxygen concentration to the kiln oxygen concentration set point to determine a difference between the oxygen concentration and the kiln oxygen concentration set point, and adjusting a flow of secondary gas into the ware space to set an oxygen flux in the atmosphere in the ware space of the kiln based on the difference between the oxygen concentration and the kiln oxygen concentration set point. A kiln for firing the ceramic green ware and a manufacturing system including the kiln for manufacturing ceramic ware are also disclosed.

This application claims the benefit of priority under 35 U.S.C. § 119 of U.S. Provisional Application Ser. No. 63/113,564 filed on Nov. 13, 2020, the content of which is relied upon and incorporated herein by reference in its entirety.

### BACKGROUND

### 1. Field

This disclosure relates to atmospheric control during the firing of ceramic articles, and more particularly to the control of oxygen during the firing of ceramic honeycomb bodies.

### 2. Technical Background

The manufacture of ceramic articles may comprise firing green bodies at a temperature sufficient to convert the green bodies into the ceramic articles, such as by reaction of one or more ceramic precursors in the green bodies into a ceramic material of the ceramic articles and/or sintering together of the ceramic material of the ceramic articles.

### SUMMARY

Disclosed herein are methods for firing ceramic green ware. In some embodiments, the method comprises setting a kiln oxygen concentration set point for an atmosphere of a ware space of a kiln during an oxygen-consuming event in the ware space of the kiln; initiating an oxygen flux control mode comprising: measuring an oxygen concentration of the atmosphere of the ware space in the kiln; comparing the oxygen concentration to the kiln oxygen concentration set point to determine a difference between the oxygen concentration and the kiln oxygen concentration set point; and adjusting a flow of secondary gas into the ware space to set an oxygen flux in the atmosphere in the ware space of the kiln based on the difference between the oxygen concentration and the kiln oxygen concentration set point.

In some embodiments, the oxygen flux control mode is implemented as a control loop over multiple cycles of the steps of measuring, comparing, and adjusting.

In some embodiments, adjusting the flow of secondary gas comprises incrementally increasing a secondary gas oxygen concentration of the secondary gas over the multiple cycles.

In some embodiments, adjusting the flow of secondary gas comprises incrementally increasing a total flow rate of the secondary gas over the multiple cycles after the secondary gas oxygen concentration has reached a maximum value.

In some embodiments, adjusting the flow of secondary gas comprises incrementally increasing a total flow rate of the secondary gas over the multiple cycles.

In some embodiments, the method comprises increasing the oxygen flux if the difference between the oxygen concentration and the kiln oxygen concentration set point is above a minimum threshold value.

In some embodiments, the method comprises decreasing the oxygen flux if the difference between the oxygen concentration and the kiln oxygen concentration set point is below a minimum threshold value.

In some embodiments, prior to initiating the oxygen flux control mode the kiln is operated in a maximum oxygen concentration control mode in which the oxygen concentration of the secondary gas was limited to at most within a control band set relative to the oxygen set point.

In some embodiments, during the oxygen flux control mode the oxygen concentration of the second gas is adjusted to a value greater than the control band.

In some embodiments, the steps of measuring and comparing also occur prior to the step of imitating, and wherein the oxygen flux control mode is implemented if the difference between the oxygen concentration and the kiln oxygen concentration set point is greater than a maximum threshold value.

In some embodiments, the step of initiating is implemented over a preset time period or over a preset kiln temperature range.

In some embodiments, the preset time period or preset kiln temperature range corresponds to an oxygen-consuming event.

In some embodiments, the secondary gas comprises a mixture of at least a first gas and a second gas, wherein the first gas has a higher oxygen concentration relative to the second gas.

In some embodiments, the first gas comprises air or oxygen.

In some embodiments, the second gas comprises nitrogen or products of combustion from burners of the kiln.

In some embodiments, adjusting the flow of secondary gas comprises altering a first flow rate of the first gas, altering a second flow rate of the second gas, altering a ratio of the first flow rate to the second flow rate, or a combination thereof.

In some embodiments, the oxygen flux control mode is implemented during an oxygen-consuming event of the green ware.

In some embodiments, the oxygen-consuming event is an exothermic event.

In some embodiments, the exothermic event relates to the burn off or combustion of one or more combustible components of the green ware.

In some embodiments, the one or more combustible components comprises graphite, oil, lubricant, organic binder, starch, or a polymer.

In some embodiments, the method comprises converting the green ware into one or more ceramic articles.

In some embodiments, the green ware comprises one or more green honeycomb bodies.

Disclosed herein are method of manufacturing ceramic articles comprising any of the methods of firing ceramic green ware disclosed above.

In some embodiments, the method of manufacturing comprises forming a batch mixture, extruding the batch mixture as an extrudate, and cutting the extrudate to form the green ware.

Disclosed herein are kilns for firing green ceramic articles. In some embodiments, the kiln comprises a ware space for receiving green ware; a sensor configured to measure an oxygen concentration in an atmosphere of the ware space; a main kiln controller configured to set a kiln oxygen concentration set point and to initiate an oxygen flux control mode; and a secondary gas controller configured to, during the oxygen flux control mode: compare the oxygen concentration to the kiln oxygen concentration set point to determine a difference between the oxygen concentration and the kiln oxygen concentration set point; and adjust a flow of secondary gas into the ware space to set an oxygen flux in the atmosphere of the ware space of the kiln based on the difference between the oxygen concentration and the kiln oxygen concentration set point.

Disclosed herein are manufacturing systems comprising the kilns according to any embodiments disclosed herein and an extruder configured to mix a batch mixture and shape the batch mixture into the green ware.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1 schematically illustrates a system for manufacturing ceramic articles according to one embodiment herein.

FIG. 2 schematically illustrates a kiln useful for conversion of green bodies into ceramic articles according to one embodiment disclosed herein.

FIG. 3 is a flowchart illustrating operation of a kiln according to one embodiment disclosed herein.

FIG. 4A is a graph illustrating the oxygen concentration of the ware space in a kiln in which an oxygen flux control mode is implemented at a time (t₁) according to one example described herein.

FIG. 4B is a graph illustrating the oxygen concentration of the ware space in a kiln over a time period in which an oxygen flux control mode is implemented according to one example described herein.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

The firing process step in the manufacture of ceramic bodies may include control of atmospheric conditions beyond only temperature control and temperature uniformity within the ware space of the kiln. As described herein, for some ceramic compositions, batch mixtures, and/or ware geometries, implementation of oxygen concentration and oxygen flux (rate of change of oxygen concentration) control may also be beneficial. Regulation of oxygen, along with temperatures of the ware space and of the ware, may directly impact thermal reactions during firing, namely, exothermic reactions. For example, by specifying oxygen concentration and/or oxygen flux as described herein, exothermic and other reactions, such as oxygen-consuming reactions, can be controlled.

Exothermic reactions release heat into the ware space, which also must be controlled. This can be accomplished at least in part by dilution through volume exchanges of the atmosphere in the ware space of the kiln with a so-called secondary gas. The secondary gas composition can be a mixture of different components, such as air, nitrogen, oxygen, water vapor, or other inert or reactive gases.

Control of exothermic reactions may be particularly useful as the total combustible load (reactive organic and inorganic portions of the batch material) is increased. For example, the combustible load of batch mixtures used to create some ceramic articles, such as high-porosity ceramic bodies, may exceed 50% by weight, e.g., due to the high level of organic binders and pore formers used.

In order to control the rate and timing of exothermic events, including the rate of release of volatile organic compounds (VOCs), a maximum oxygen concentration process control mode can be implemented in which the oxygen concentration of the secondary gas is limited to a value within a process control band from a maximum oxygen concentration set point for the ware space of the kiln (e.g., within +/−2% O₂ of the maximum oxygen concentration set point, where the % is provided as a % volume as an absolute value with respect to 100% oxygen). Since oxygen is being supplied into the ware space of the kiln primarily, if not essentially solely, via the secondary gas, limiting the oxygen concentration of the secondary gas to the maximum oxygen concentration set point for the kiln ensures that the oxygen concentration in the ware space never exceeds the maximum oxygen concentration set point.

However, as described further herein, it has been found by the current inventors that the actual oxygen concentration in the ware space of the kiln may, particularly during an exothermic or other oxygen-consuming event, drop to levels significantly below that of the maximum oxygen concentration set point. The lack of available oxygen may result in a delay of completion of the exothermic event (e.g., delay in completion of the burn off of one or more combustible components, such as the organic binder or pore former). A delay in completion of the exothermic or other event may complicate the firing process, such as by causing thermal gradients in the parts and/or requiring an increased amount of secondary gas to be exchanged at relatively higher kiln temperatures, at which higher temperatures these issues are more difficult and/or costly to address.

The delay in completion of the burn off of a combustible component or other exothermic event may be particularly pronounced if a subsequent thermal event, such as an endothermic event, occurs in the green bodies. For example, a clay-containing green body may undergo dehydration of clay components (the dehydration referring to the removal of chemically bonded water, which may be referred to herein as a “water loss” event) at about 500° C. (e.g., from about 500° C. to about 600° C.) or a talc-containing green body may undergo talc dehydration, or water loss, starting at about 850° C. (e.g., from about 850° C. to about 950° C.). The temperature ranges for various events are provided as estimates, as these temperatures may vary batch to batch depending on the particular components and amounts of components in each batch mixture.

In these scenarios, if such a subsequent thermal event is initiated during burn off of a combustible component, completion of the burn off of that combustible component may be delayed to a later time during, or in some instances even after the subsequent event ends. For example, if graphite is not completely burned off before talc water loss starts, the residual graphite in the green ware may remain in the green ware until a later time during the talc water loss event, or even after the talc water loss event ends. Similarly, if the burn off of starch, methylcellulose, oil, lubricants, or other organic components is not completed before the initiation of clay water loss, these organic components may remain partially in green ware until after the clay water loss event ends. The delay of burn off may make it more difficult and/or costly to handle the excess heat and/or release of volatile components at later times (e.g., which often correspond to higher temperatures unless a temperature hold is implemented, which is also costly and time consuming). Additionally, the delay of completion of such burn off events may result in increased tendency of defects, such as cracks, to form in the ceramic article, such as due to the formation of undesirably high thermal gradients in the part when the completion of burn off is delayed until higher temperatures.

Accordingly, described herein are methods and systems for firing green bodies, which employ an oxygen flux control mode for the atmosphere of the ware space of the kiln. When operating under the oxygen flux control mode according to embodiments described herein, the oxygen flux can be given a hierarchy dominance, such that the oxygen concentration of the secondary gas is not limited by the maximum oxygen set point (e.g. not limited to a control band relative to the maximum oxygen set point, such as within +/−2% of the maximum oxygen set point). Accordingly, as oxygen is consumed in the ware space of the kiln, the oxygen concentration of the secondary gas is correspondingly set in order to control the oxygen flux in the ware space of the kiln.

In some embodiments, the oxygen concentration of the secondary gas during the oxygen flux control mode, as described with respect to embodiments herein, is implemented in conjunction with the maximum oxygen concentration set point. In this way, the oxygen concentration of the secondary gas can be set at a value above the maximum oxygen concentration set point of the kiln in order to control oxygen flux in the ware space of the kiln, while the actual oxygen concentration in the ware space is maintained at or below the maximum oxygen concentration set point. Accordingly, when used in conjunction together, the kiln can be operated such that the temperature of the ware and the heat release from the kiln is still controlled (e.g., via sufficient volumetric exchanges with the secondary gas), while the reaction rates (e.g., burn off of combustible components) is still maintained within acceptable levels. In some embodiments, instead of stepping the oxygen concentration of the secondary gas up to maintain a minimum level of oxygen available in the ware space of the kiln, the oxygen flux control mode is alternatively or additionally operated to step the oxygen concentration of the secondary gas down in order to maintain a maximum oxygen flux and/or the maximum oxygen set point for the ware space of the kiln.

The systems and methods described herein advantageously maintains desired ware space oxygen levels regardless of the level of oxygen consumption within the ware space. As a result, improved control over and handling of the exothermic reactions and other events, such as oxygen-consuming events, within the ware space are achieved. Additionally, the systems and methods described herein can be useful in maintaining desired ware space volume exchanges, which assists in facilitating desired convective heat removal and/or VOC dilution. The embodiments described herein may also facilitate using lower amounts of volume exchanges (particularly at higher temperatures where occurrence of the exothermic reactions would otherwise be delayed) which reduces risk of environmental non-compliance in the after-treatment system (e.g., thermal oxidizer) of the kiln and reduces the energy required to heat up the volume exchanges in both the ware space and in any such aftertreatment system.

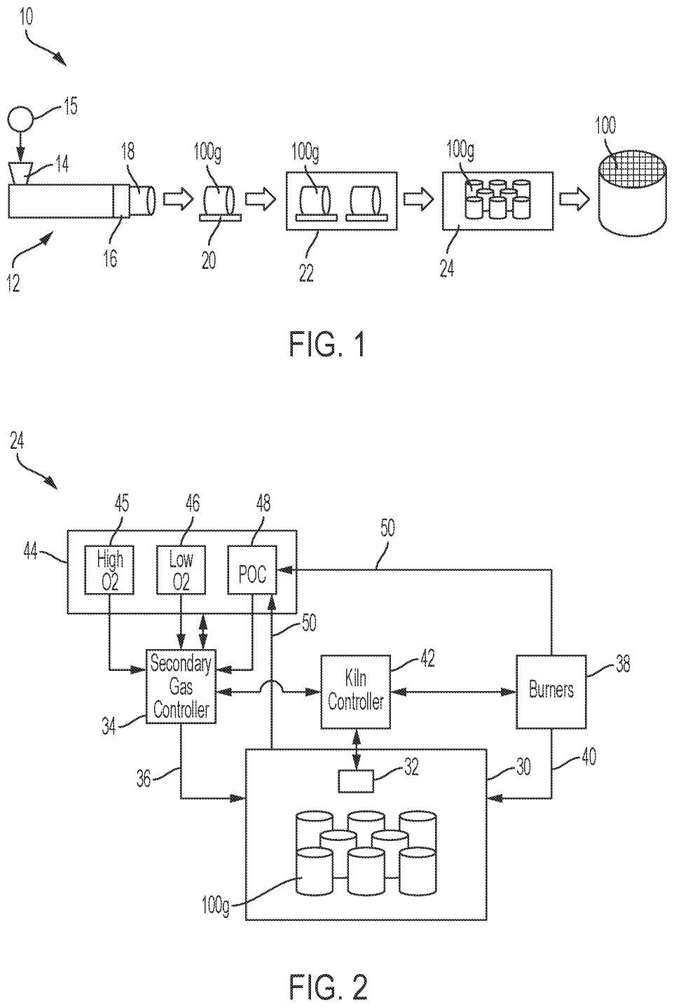

Referring to FIG. 1, a manufacturing system 10 is illustrated for ultimately forming ceramic article 100, which is illustrated in FIG. 1 as a ceramic honeycomb body. The manufacturing system 10 comprises an extruder 12 that comprises an inlet 14, such as a hopper, for receiving a mixture 15 of ceramic-forming components, e.g., ceramic and/or ceramic precursors, which may be referred to herein as the batch mixture 15. The extruder 12 can comprise one or more rotatable screws, a ram, or other mechanism for mixing and/or pressurizing the batch mixture 15 within the body of the extruder 12.

The extruder 12 comprises an extrusion die 16 through which the pressurized batch mixture 15 is forced. For example, the extrusion die 16 can comprise a plurality of slots through which an extrudate 18 is extruded. The slots of the extrusion die 16 can correspond to a honeycomb structure if the ceramic article 100 is intended to be a ceramic honeycomb body. Lengths of the extrudate 18 can be cut off (e.g., via a blade, saw, vibratory cutter, laser, wire, or other cutting device) to form one or more green bodies 100g. The green bodies 100g can be placed on a tray, belt, sheet, conveyor, or other transport mechanism 20 or combination of transport mechanisms for transportation to subsequent manufacturing steps. The green bodies 100g can be dried in a dryer 22 to remove water or other liquid carrier present, e.g., using elevated temperature, air flow, microwaves, etc. After drying, the dry green bodies 100g can be transported to a kiln 24 in which the green bodies 100g are fired. As described herein, the firing process can be used to convert the green bodies 100g into the ceramic articles 100, such as by reaction and/or sintering of materials in the green bodies 100g.

The batch mixture 15 can one or more ceramic and/or ceramic-forming materials (e.g., that result in one or more ceramic phases to be formed in the ceramic article 100 during firing) that may be collectively referred to herein as “ceramic precursors”, such as clay, talc, alumina, titania, silica, and other oxides. The batch mixture can further comprise an organic binder such as methylcellulose (e.g., to enable extrudability in the desired shape of the green body 100g and maintain green strength during subsequent manufacturing steps), pore formers such starches, polymers, and graphite, (e.g., materials that are burned off or otherwise react at firing temperatures to form or leave voids in the resulting ceramic material), extrusion aids such as lubricants or oils (e.g., to reduce extrusion pressure, reduce friction of abrasive particles in the batch mixture, and/or impart a desired rheology to the batch mixture), sintering aids to assist in the sintering together of ceramic components during firing (e.g., to increase strength of the ceramic article 100 after firing), and a liquid carrier such as water (e.g., to enhance mixability and extrudability of the batch mixture 15). The ceramic precursors can be selected so that the ceramic article 100, as a result of firing, comprises one or more ceramic phases, such as one or more of cordierite, mullite, aluminum titanate, and silicon carbide.

In some embodiments, the green ware to be fired (e.g., the green honeycomb bodies 100g) and correspondingly the batch mixture from which the green ware is made (e.g., the batch mixture 15), has a total combustible load (total amount of all components that will burn off or otherwise combust during firing) of at least 4 wt %, at least 8 wt %, at least 12 wt %, at least 15 wt %, at least 20 wt %, at least 25 wt %, at least 30 wt %, at least 35 wt %, or even at least at least 40 wt % such as up to 45 wt % or even 50 wt % or more, each value as super addition with respect to a total weight of the inorganics in the batch mixture, including ranges having these values as endpoints, such as from about 4 wt % to about 50 wt %, from about 4 wt % to about 45 wt %, from about 4 wt % to about 40 wt %, from about 8 wt % to about 50 wt %, from about 12 wt % to about 50 wt %, from about 15 wt % to about 50 wt %, from about 20 wt % to about 50 wt %, from about 25 wt % to about 50 wt %, from about 30 wt % to about 50 wt %, or even from about 35 wt % to about 50 wt %, each range again given in wt % super addition. For example, in some embodiments the amount of pore former (e.g., graphite and starch) is at least 10 wt %, at least 15 wt %, at least 20 wt %, at least 25 wt %, at least 30 wt %, or even at least 35 wt %, such as up to 40 wt % or 45 wt %, including ranges having these values as end points, each value given as a super addition with respect to the total weight of inorganics. In some embodiments, the amount of organic binder (e.g., methylcellulose) is in an amount of at least 3 wt %, at least 4 wt %, at least 5 wt %, or even at least 6 wt %, such as up to 8 wt % or even 10 wt %, including ranges having these values as end points, each value given as a super addition with respect to the total weight of inorganics. In some embodiments, the amount of oils and lubricants is at least 1 wt %, at least 2 wt %, at least 3 wt %, at least 4 wt %, or event at least 5 wt %, such as up to 7 wt % or even 8 wt %, including ranges having these values as end points, each value given as a super addition with respect to the total weight of inorganics. The total weight of inorganics as referred to anywhere in this disclosure is considered with respect to when the batch mixture or green ware is dry, i.e., before addition of water or other liquid vehicle and/or after drying.

In some embodiments, the combustible load is determined as the sum of carbon-containing components in the green body 100g, such as pore formers (graphite, starch, polymers), oils (e.g., mineral oil, polyalphaolefin, etc.), extrusion aids, lubricants, or other additives (e.g., fatty acids, tall oil, palm olein, oleic acid, etc.), and the organic binder (e.g., methylcellulose). In general, burn off of any of these combustible components will result in a corresponding exothermic event during firing. For example, oils, lubricants, and organic binders may undergo autoignition (initiate combustion or burn off) in a temperature range of 100° C. to 350° C., while graphite may undergo autoignition at temperatures above about 550° C.

FIG. 2 illustrates the kiln 24 according to one embodiment, which can be used in the system 10 or other ceramic manufacturing system. In the illustrated embodiment of FIG. 2, the kiln 24 comprises a main chamber or ware space 30 for receiving the ware to be heated, such as the green bodies 100g. The kiln 24 additionally comprises one or more sensors 32 configured to measure one or more variables of the kiln 24, such as the oxygen (02) concentration or temperature of the atmosphere within the ware space 30. The kiln 24 also comprises a secondary gas controller 34 configured to supply a gas mixture 36 (which may be referred to interchangeably as the “secondary gas” or “secondary gas mixture”) into the ware space 30 of the kiln 24.

The kiln 24 further comprises one or more burners 38 to provide heat 40 for controlling the temperature within the ware space 30. While not shown in FIG. 2, the burners 38 can be provided with a primary gas mixture (e.g., controlled by a primary gas controller, also not shown) comprising oxygen and fuel at a ratio suitable for combustion, which is separate from the secondary gas mixture 36. In some embodiments, the burners 38 can be arranged as part of an assembly with a dual tube design that enables the secondary gas 36 to be delivered into the kiln ware space 30 via a secondary tube that is separate from a primary tube that delivers the primary gas to the burners 38 for combustion. In some embodiments, the heat 40 is provided by a heat source other than the burners 38, such as one or more radiative or resistive heating elements.

The kiln 24 also comprises a main kiln controller 42 (alternatively, a master kiln controller) that is in signal communication (e.g., wired or wireless connection) with the sensor(s) 32, the secondary gas controller 36, and/or the burners 38 in order to control and/or monitor operation of the kiln 24. For example, the kiln controller 42 can implement set points (target values) for one or more variables related to operation of the kiln 24 (such as temperature or oxygen concentration of the atmosphere within the ware space 30). Accordingly, operation of various components of the kiln 24 can be controlled at least in part by the set points. The kiln controller 42 can also monitor (measure) one or more operating variables of the kiln 24 via the sensors 32 as described herein.

Although illustrated in FIG. 2 as separate entities, the secondary gas controller 34 can be comprised by the kiln controller 42, the secondary gas controller 34 and the kiln controller 42 can be comprised by the same computing device, and/or the secondary gas controller 34 and the kiln controller 42 can otherwise share computing resources. For example, in some embodiments the secondary gas controller 34 and the kiln controller 42 are arranged as separate software routines, modules, or other software components implemented on common hardware, while in some embodiments the controllers 34 and 42 are arranged as separate software components implemented on separate hardware devices.

In order to control the oxygen concentration of the secondary gas 36, the secondary gas controller 34 can be in communication with a gas mixing assembly 44 that comprises or is otherwise in fluid communication with multiple sources of different gases that have different oxygen concentrations, such as at least a high oxygen gas source 45 and a low oxygen gas source 46 as shown in FIG. 2. The gas mixing assembly 44 can comprise a common mixing chamber that is in selective fluid communication with each of the gas sources via valves, pumps, or other mechanisms that can be controlled (e.g., by setting the pump speed or valve position), e.g., via instructions from the secondary gas controller 34, to adjust relative flows rates, amounts, and/or ratios of the different gases that make up the secondary gas mixture 36.

In this way, the characteristics of the secondary gas mixture 36 (such as volumetric flow rate and/or oxygen concentration) can be set by the mixing assembly 44 based on the flow rates and/or ratios of the different gas sources. For example, the secondary gas controller 34 can set a first flow rate for the high gas source 45 and a second flow rate for the low gas source 46 in order to set a flow rate and an oxygen concentration for the secondary gas mixture 36. For example, increasingly higher flow rates for the high oxygen gas source 45 and/or the low oxygen gas source 46 can be used to increase the total flow rate of the secondary gas 36, while the ratio of a first flow rate of the high oxygen gas source 45 relative to a second flow rate of the low oxygen gas source 46 can be used to adjust the oxygen concentration of the secondary gas 36.

The high oxygen gas source 45 can comprise pure oxygen, ambient air (thus having oxygen at a concentration of approximately 21%), or other oxygen-rich gas (e.g., having an oxygen concentration of at least about 20%). The low oxygen gas source 46 can comprise a gas having a relatively lower amount of oxygen, such as less than 5% oxygen, or even no oxygen. Unless specified otherwise, the percentage of oxygen within a gas mixture is given herein as % volume. In some embodiments, the low oxygen gas is an inert gas, such as nitrogen.

In some embodiments, the secondary gas controller 34 and/or gas mixing assembly 44 can also or alternatively be in fluid communication with a source 48 of the products of combustion (POC) 50 from the kiln 24, the burners 38, and/or another source such as a separate generator if the kiln 24 is arranged as part of a cogeneration system. In some embodiments, the secondary gas mixture 36 is created as a mixture of all three of the high oxygen gas (e.g., air), the low oxygen gas (e.g., nitrogen), and the products of combustion from the burners. In some embodiments, the POC source 48 is used as the low oxygen gas source 46 (e.g., the POC source 48 and the low oxygen gas source 46 are the same), such that the products of combustion 50 from the burners 38 are used as the low oxygen gas.

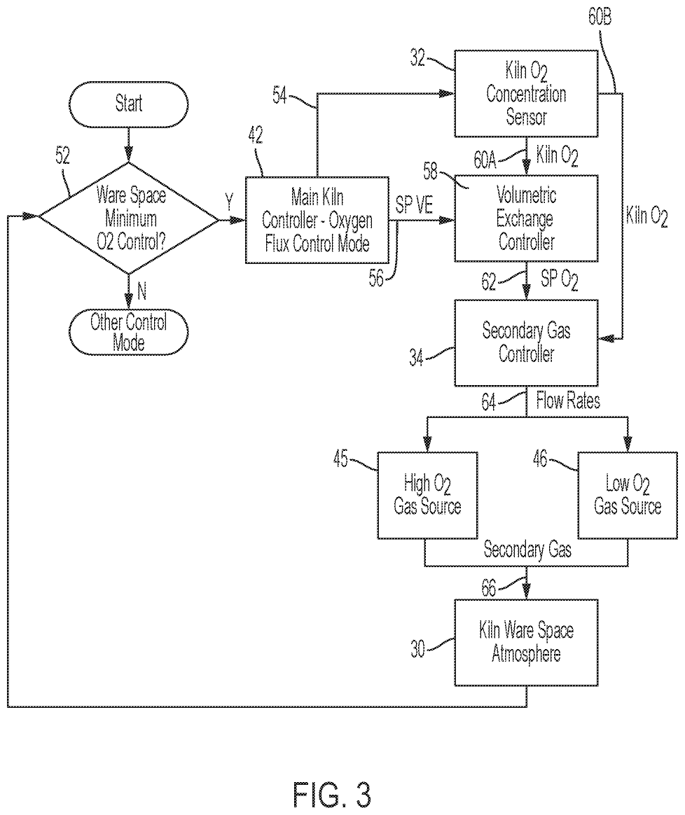

Further operation of kilns (e.g., the kiln 24) according to embodiments of firing green ware (e.g., the green bodies 100g) disclosed herein can be appreciated in view of the flowchart of FIG. 3. In FIG. 3, it is first determined in step 52 whether an oxygen flux control mode, as described herein, is to be implemented. The determination of step 52 can be made by a main kiln controller (e.g., the main kiln controller 42). As shown and described herein, as long as the oxygen flux control mode is required, the flowchart of FIG. 3 can be implemented as a control loop in which the oxygen flux is adjusted over multiple cycles. For example, the step 52 can be checked once every second or other time interval. When the oxygen flux control mode is no longer required, the kiln can be operated under any other known and suitable control methodologies.

Initiation of the oxygen flux control mode can be triggered at preset times, over preset temperature ranges, manually by a user or operator of the kiln, and/or otherwise in response to the detection or determination of one or more events as described herein. For example, in some embodiments, the kiln 24 is operated by default in a maximum oxygen concentration control mode (as described above), where the oxygen concentration in the ware space of the kiln is maintained below a certain maximum, e.g., in order to maintain sufficiently low levels of volatile compounds in the kiln atmosphere and/or to limit the rate of combustion of combustible compounds in the green ware (e.g., prevent runaway combustion).

In some embodiments, the initiation of oxygen flux control mode is preprogrammed into the main kiln controller 42, such as to occur at a certain preset time or when a certain preset temperature is reached (e.g., as measured by the sensor(s) 32). In some embodiments, the time or temperature that triggers initiation of the oxygen flux control mode corresponds to a time period and/or temperature range at which burn out of one or more combustible components of the green ware is known to occur, e.g., from about 150° C. to about 350° C. for many organic components, such as oils, lubricants, organic binders such as methylcellulose, and organic pore formers such as starch or polymers, or temperatures above about 550° C. for graphite pore formers. The temperatures at which burn off or other thermal events occur (both exothermic and endothermic) can be identified experimentality by observing the temperature of the green honeycomb body in comparison to the kiln temperature over time and/or with the assistance of any suitable analytical technique such as differential scanning calorimetry (DSC), or thermal gravimetric analysis (TGA).

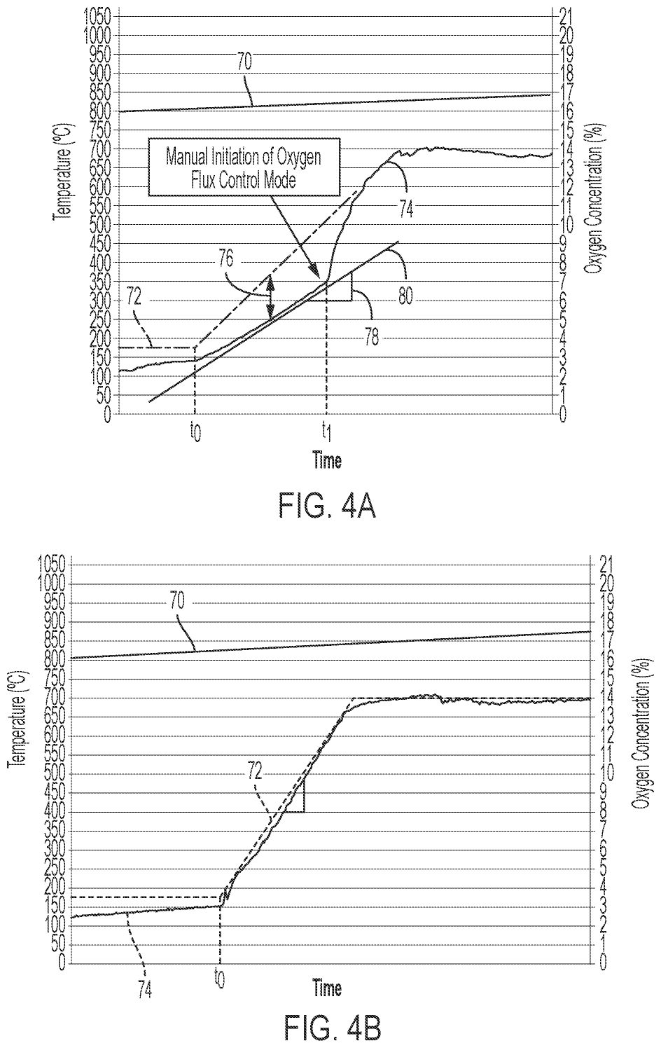

In some embodiments, the main kiln controller 42 initiates the oxygen flux control mode upon detection that a difference between the kiln ware space O₂ set point and the observed kiln oxygen concentration (e.g., measured by the sensor(s) 32), which difference may be referred to herein as the oxygen delta (described in more detail with respect to FIGS. 4A-4B below), has surpassed a maximum threshold value. In other words, the kiln controller 42 can be configured to initiate the oxygen flux control mode when the measured ware space oxygen concentration drops too far below the oxygen concentration set point for the ware space 30.

For example, the preset maximum threshold value can be a difference in oxygen concentration of at most 1%, at most 0.75%, at most 0.5%, or even at most 0.25%, given as an absolute value with respect to 1000% oxygen concentration. For example, if the maximum kiln ware space oxygen concentration set point is set at 8% oxygen concentration, and the maximum threshold value is set at 2%, then the main kiln controller will initiate the oxygen flux control mode when the measured oxygen concentration drops below 6%. The main kiln controller 42 (or other controlled in signal communication therewith) can be configured to periodically (e.g., every second, every minute, or other time interval) calculate the oxygen delta by performing a comparison between the maximum oxygen concentration set point and the measured oxygen concentration.

In some embodiments, the main kiln controller 42 can be configured to receive an initiation signal due to user input. For example, a technician, operator, or other user managing operation of the kiln 24 can manually trigger initiation, such as by issuing a command to the main kiln controller 42, e.g., utilizing a mouse, keyboard, button, switch, touchscreen, or other input device in signal communication with the main kiln controller 42.

Once the oxygen flux control mode is initiated, the main kiln controller 42 sends one or more control signals to other components of the kiln. For example, the main kiln controller 42 can send a signal to instruct the oxygen concentration sensor (e.g., the sensor 32) to measure the ware space oxygen concentration (designated in FIG. 3 as “Kiln 02”) at step 54. Alternatively, the sensor 32 can be configured to periodically measure the ware space oxygen concentration and routinely output the measured value without separate instruction.

The main kiln controller 42 can also send a signal at step 56 indicating the value of a volumetric exchange set point (designated as “SP VE” in FIG. 3) for the secondary gas. In FIG. 3, the volumetric exchange set point is output to a volumetric exchange controller 58, which is configured to calculate the volumetric exchange of the various gases within the kiln, e.g., the volumetric exchange of the secondary gas 36. As described with respect to the main kiln controller 42 and the secondary gas controller 34 in FIG. 2, any of the controllers herein may be implemented by shared hardware and/or shared computing resources, or as separate hardware or computing resources. For example, the main kiln controller can comprise the volumetric exchange controller.

The measured kiln oxygen concentration can be output to the controllers that require this value for further calculations, either directly by the sensor 32 or indirectly via the main kiln controller 42 or other controller. In the embodiment of FIG. 3, the measured kiln oxygen concentration is output to the volumetric exchange controller 58 at step 60A and to the secondary gas controller at step 60B. The volumetric exchange controller 58 receives the volumetric exchange set point and the measured kiln oxygen concentration and determines a maximum oxygen concentration set point (designated as SP 02 in FIG. 3) for the ware space of the kiln, which is output at step 62 to the secondary gas controller 34.

As generally described above, the secondary gas controller receives the maximum oxygen concentration set point and the measured kiln oxygen concentration and determines flow rates for the various gas sources from which the secondary gas mixture 36 is made. As shown in FIG. 3, signals corresponding to the flow rates for at least the high oxygen gas source 45 and the low oxygen gas source 46 (in addition to any other gas sources, such as the POC gas source 48) are communicated at step 64. The secondary gas 36 resultantly is mixed in the relative amounts corresponding to the flow rate signals and provided into the atmosphere of the kiln ware space 30 at step 66. As noted above, the methodology of FIG. 3 can be repeated as a control loop over multiple cycles until the oxygen flux control mode is no longer necessary or desired.

The secondary gas controller 34 when operating in the oxygen flux control mode can implement, e.g., incrementally, a larger range of oxygen concentration for the secondary gas 36. For example, the oxygen concentration of the secondary gas 36 can be increased to values greater than the maximum oxygen set point for the atmosphere of the ware space 30 of the kiln 24. If the oxygen flux cannot be sufficiently increased so that the measured oxygen concentration is still below the maximum oxygen concentration set point (or some minimum threshold from the maximum oxygen concentration set point), the volumetric exchange (flow rate of secondary gas) increases, e.g., incrementally, to the set point. A maximum possible volumetric exchange rate can be preprogrammed, e.g., into memory of the kiln controller 42.

In some embodiments, when implemented as a repeatable control loop, the flow rate of the high oxygen gas source 45 is adjusted to incrementally increase the oxygen concentration of the secondary gas 36 by a set amount in each cycle of the control loop. For example, the flow rate of the high oxygen gas source 45 can be adjusted in some embodiments to increase the oxygen concentration of the secondary gas 36 by an amount of about 0.01% (as an absolute value) each cycle. In addition to increasing the oxygen concentration of the second gas 36, the total volumetric exchange (flow rate) of the secondary gas can also be increased. The desired oxygen concentration for the secondary gas 36 can be maintained, even as the total volumetric exchange of the secondary gas 36 is increased, by increasing the flow rates of each of the gas sources while maintaining the same ratio between the flow rates of the different gases. Increasing the total volumetric exchange of the secondary gas may be particularly useful in embodiments in which the oxygen flux cannot be sufficiently increased even after incrementally increasing the oxygen concentration of the secondary gas to its feasible maximum. For example, if air is used as the high oxygen gas, then the oxygen concentration of the secondary gas has a limit of 21% when the secondary gas consists essentially of only the air.

FIGS. 4A and 4B include graphs showing a kiln temperature set point and measured oxygen concentration in the ware space of a kiln (e.g., the ware space 30 of the kiln 24) according to example investigations performed by the current inventors. More particularly, FIG. 4A illustrates a first example in which the kiln is operated in a first mode of operation until a time t1, at which time the kiln is operated in accordance with the oxygen flux control mode, as generally described above with respect to FIGS. 2 and 3. Lines corresponding to the kiln temperature set point and the maximum ware space oxygen concentration set point are plotted in FIG. 4A and designated with numerals 70 and 72, respectively. Additionally, a line corresponding to the measured oxygen concentration is designated in FIGS. 4A and 4B with the reference numeral 74.

In the examples of FIGS. 4A and 4B, a batch mixture comprising both graphite and talc was utilized to make honeycomb green ware (e.g., the green bodies 100g), which were loaded into the ware space of a kiln. The data of FIGS. 4A and 4B corresponds to a temperature range of about 800 C-850 C, and thus, at a temperature at which graphite is being combusted just prior to the initiation of a talc water loss event in the green ware.

At a time t0 the oxygen set point 72 is set to ramp from a first oxygen concentration of about 3.5% (at a temperature of about 800° C.) to a second oxygen concentration of about 14% (at a temperature of about 825° C.). Due at least in part to the consumption of oxygen by the burn off of the graphite component from the green ware, the measured oxygen concentration 74 increasingly deviates from the targeted value of the oxygen concentration set point 72 over time. As noted herein, the deviation or difference between the measured oxygen concentration 74 and the maximum oxygen concentration set point 72 may be referred to as an oxygen delta, which is designated in FIG. 4A with the reference numeral 76. Thus, the oxygen delta 76 can be calculated as the difference between the measured oxygen concentration 74 and the maximum oxygen concentration set point 72 at any given time. For example, the oxygen delta 76, as an absolute value, is about 0.5%—0.75% at time t0 and increased to about 3%-3.25% at time t1.

At time t1 the oxygen flux control mode was manually implemented by user intervention, which caused the measured kiln oxygen concentration 74 to immediately increase until the measured kiln oxygen concentration approximated the kiln oxygen set point 72. The oxygen flux can be understood as the change in measured oxygen concentration over time, or dO₂/dt. For example, the oxygen flux can be appreciated in FIG. 4A as approximately equal to a slope 78 of a trend line 80 inserted in FIG. 4A, which trend line 80 corresponds approximately to the maximum slope of the measured oxygen concentration 74.

Before the oxygen flux control mode was implemented, the oxygen flux had a value that was significantly less than the rate of oxygen change corresponding to the oxygen concentration set point 72 (which can likewise be determined by the slope of the oxygen concentration set point 72). However, once the oxygen flux control mode was implemented, the oxygen flux steeply increased until the measured oxygen concentration 74 approximated the maximum oxygen concentration set point 72.

For comparison, FIG. 4B illustrates the same parameters of FIG. 4A, but where the oxygen flux control mode is implemented at time t0 in conjunction with the ramp in the oxygen concentration set point 72. Accordingly, as shown in FIG. 4B, implementation of the oxygen flux control mode enabled the measured kiln oxygen concentration 74 approximate the kiln oxygen concentration set point 72 over the entirety of the ramp in the oxygen set point.

Additionally, in accordance with the description herein, the measured oxygen concentration 74 did not significantly exceed the oxygen set point 72 by controlling the oxygen flux with respect to a minimum threshold value for the delta oxygen 76. That is, as noted herein, the oxygen flux can be both increased (e.g., when the oxygen delta is particularly high and/or above some threshold value) in order to ensure a minimum amount of oxygen is available as well as decreased to prevent the actual oxygen concentration in the ware space of the kiln from exceeding the set point (e.g., when the oxygen delta is relatively low and/or below some threshold value). Accordingly, in the investigation of FIG. 3, the minimum threshold value for the oxygen delta was set at 1%, and the oxygen flux (slope of the measured oxygen concentration 74) correspondingly decreased once the oxygen delta 76 dropped to values less than the set minimum threshold value of 1% oxygen.

In some embodiments, the methods, techniques, microprocessors, and/or controllers described herein are implemented by one or more special-purpose computing devices having designated hardware and/or software components for implementing the herein-described methodologies and operations. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. The instructions can reside in RAM memory, flash memory, ROM memory, EPROM memory, EEPROM memory, registers, hard disk, a removable disk, a CD-ROM, or any other form of non-transitory computer-readable storage medium. The special-purpose computing devices may be desktop computer systems, server computer systems, portable computer systems, handheld devices, networking devices or any other device or combination of devices that incorporate hard-wired and/or program logic to implement the techniques. The processor(s) and/or controller(s) described herein can be coordinated by any suitable operating system software.

In some embodiments, parts of the techniques disclosed herein are performed by a processor (e.g., a microprocessor) and/or other controller elements in response to executing one or more sequences instructions contained in a memory. Such instructions may be read into the memory from another storage medium, such as a storage device. Execution of the sequences of instructions contained in the memory may cause the processor or controller to perform the process steps described herein. In alternative embodiments, hard-wired circuitry may be used in place of or in combination with software instructions.

It will be apparent to those skilled in the art that various modifications and variations can be made without departing from the spirit or scope of the claimed subject matter. Accordingly, the claimed subject matter is not to be restricted except in light of the attached claims and their equivalents.

1. A method for firing ceramic green ware, the method comprising:
setting a kiln oxygen concentration set point for an atmosphere of a ware space of a kiln during an oxygen-consuming event in the ware space of the kiln;
initiating an oxygen flux control mode comprising:
measuring an oxygen concentration of the atmosphere of the ware space in the kiln;
comparing the oxygen concentration to the kiln oxygen concentration set point to determine a difference between the oxygen concentration and the kiln oxygen concentration set point; and
adjusting a flow of secondary gas into the ware space to set an oxygen flux in the atmosphere in the ware space of the kiln based on the difference between the oxygen concentration and the kiln oxygen concentration set point.

2. The method of claim 1, wherein the oxygen flux control mode is implemented as a control loop over multiple cycles of the steps of measuring, comparing, and adjusting.

3. The method of claim 2, wherein adjusting the flow of secondary gas comprises incrementally increasing a secondary gas oxygen concentration of the secondary gas over the multiple cycles.

4. The method of claim 3, wherein adjusting the flow of secondary gas comprises incrementally increasing a total flow rate of the secondary gas over the multiple cycles after the secondary gas oxygen concentration has reached a maximum value.

5. The method of claim 2, wherein adjusting the flow of secondary gas comprises incrementally increasing a total flow rate of the secondary gas over the multiple cycles.

6. The method of claim 1, comprising increasing the oxygen flux if the difference between the oxygen concentration and the kiln oxygen concentration set point is above a minimum threshold value.

7. The method of claim 1, comprising decreasing the oxygen flux if the difference between the oxygen concentration and the kiln oxygen concentration set point is below a minimum threshold value.

8. The method of claim 1, wherein prior to initiating the oxygen flux control mode the kiln is operated in a maximum oxygen concentration control mode in which the oxygen concentration of the secondary gas was limited to at most within a control band set relative to the oxygen set point.

9. The method of claim 7, wherein during the oxygen flux control mode the oxygen concentration of the second gas is adjusted to a value greater than the control band.

10. The method of claim 1, wherein the steps of measuring and comparing also occur prior to the step of imitating, and wherein the oxygen flux control mode is implemented if the difference between the oxygen concentration and the kiln oxygen concentration set point is greater than a maximum threshold value.

11. The method of claim 1, wherein the step of initiating is implemented over a preset time period or over a preset kiln temperature range.

12. The method of claim 11, wherein the preset time period or preset kiln temperature range corresponds to an oxygen-consuming event.

13. The method of claim 1, wherein the secondary gas comprises a mixture of at least a first gas and a second gas, wherein the first gas has a higher oxygen concentration relative to the second gas.

14. The method of claim 13, wherein the first gas comprises air or oxygen.

15. The method of claim 13, wherein the second gas comprises nitrogen or products of combustion from burners of the kiln.

16. The method of claim 13, wherein adjusting the flow of secondary gas comprises altering a first flow rate of the first gas, altering a second flow rate of the second gas, altering a ratio of the first flow rate to the second flow rate, or a combination thereof.

17. The method of claim 1, wherein the oxygen flux control mode is implemented during an oxygen-consuming event of the green ware.

18. The method of claim 17, wherein the oxygen-consuming event is an exothermic event that relates to the burn off or combustion of one or more combustible components of the green ware, the one or more combustible components comprising graphite, oil, lubricant, organic binder, starch, or a polymer.

19. (canceled)

20. (canceled)

21. (canceled)

22. (canceled)

23. A method of manufacturing ceramic articles, comprising:
forming a batch mixture;
extruding the batch mixture as an extrudate;
cutting the extrudate to form a ceramic green ware; and
firing the ceramic green ware to convert the ceramic green ware into one or more ceramic articles,
wherein firing the ceramic green ware comprises:
setting a kiln oxygen concentration set point for an atmosphere of a ware space of a kiln during an oxygen-consuming event in the ware space of the kiln;
initiating an oxygen flux control mode comprising:
measuring an oxygen concentration of the atmosphere of the ware space in the kiln;
comparing the oxygen concentration to the kiln oxygen concentration set point to determine a difference between the oxygen concentration and the kiln oxygen concentration set point; and
adjusting a flow of secondary gas into the ware space to set an oxygen flux in the atmosphere in the ware space of the kiln based on the difference between the oxygen concentration and the kiln oxygen concentration set point.

24. (canceled)

25. A kiln comprising:
a ware space for receiving green ware;
a sensor configured to measure an oxygen concentration in an atmosphere of the ware space;
a main kiln controller configured to set a kiln oxygen concentration set point and to initiate an oxygen flux control mode; and
a secondary gas controller configured to, during the oxygen flux control mode:
compare the oxygen concentration to the kiln oxygen concentration set point to determine a difference between the oxygen concentration and the kiln oxygen concentration set point; and
adjust a flow of secondary gas into the ware space to set an oxygen flux in the atmosphere of the ware space of the kiln based on the difference between the oxygen concentration and the kiln oxygen concentration set point.

26. (canceled)
